(19) United States
(12) Patent Application Publication
(10) Pub. No.: US 2023/0048986 A1
(43) Pub. Date: Feb. 16, 2023

(54) GLASS

(71) Applicant: AGC Inc., Tokyo (JP)

(72) Inventors: Akira SHIBATA, Tokyo (JP); Shinichi AMMA, Tokyo (JP)

(73) Assignee: AGC Inc., Tokyo (JP)

(21) Appl. No.: 17/972,043

(22) Filed: Oct. 24, 2022

Related U.S. Application Data
(63) Continuation of application No. PCT/JP2021/005439, filed on Feb. 15, 2021.

(30) Foreign Application Priority Data
Apr. 28, 2020 (JP) 2020-079230

(51) Int. Cl. C03C 4/08; C03C 3/068

(52) U.S. Cl. CPC C03C 4/087; C03C 3/068; C03C 2201/3417

(57) ABSTRACT

Glass has a refractive index of 1.55 or more, and has, in an x-ray absorption fine structure (XAFS) analysis of platinum, a peak intensity ratio expressed by Aₘₐₓ/Aₐᵥₑ of 1.13 or more, where Aₘₐₓ denotes a maximum value of a white line within an energy range of 13,270 eV to 13,290 eV, and Aₐᵥₑ denotes an average absorption in an energy range of 13,290 eV to 13,390 eV.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2021/005439 filed on Feb. 15, 2021 and designating the U.S., which claims priority to Japanese Patent Application No. 2020-079230 filed on Apr. 28, 2020. The entire contents of the foregoing applications are incorporated herein by reference.

### BACKGROUND OF THE INVENTION

### 1. Field of the Invention

The present disclosure relates to glass.

### 2. Description of the Related Art

Nowadays, there is growing demand for high-transmittance glass that has a high refractive index in various fields such as head-mounted displays (HMD) that support AR, VR, MR, and the like.

It has been reported that the transmittance of manufactured glass decreases in a case where platinum has been mixed into molten glass during the manufacturing of high-transmittance glass. For this reason, various strategies for suppressing the mixing of platinum into glass in the glass melting step are being proposed (see PTL 1 and PTL 2, for example).

However, it is not easy to control or suppress the amount of platinum that gets mixed into molten glass in actual glass manufacturing facilities to a high degree. In particular, in a case where platinum members are frequently used in the step of manufacturing molten glass, it is virtually impossible to suppress the mixing of platinum into molten glass.

Therefore, there is demand for strategies that can effectively suppress a decrease in transmittance even in a case where some platinum gets mixed into glass during the manufacturing phase.

The present disclosure has been made in view of such a background, and it is an objective of an aspect of the present disclosure to provide glass that can effectively maintain a high transmittance even in a case where the glass contains some platinum.

### CITATION LIST

### Patent Literature

PTL 1: Japanese Laid-Open Patent Publication No. 2014-224024
PTL 2: Japanese Laid-Open Patent Publication No. 2019-19050

### SUMMARY OF THE INVENTION

An aspect of the present disclosure is glass that has a refractive index of 1.55 or more, and has, in an x-ray absorption fine structure (XAFS) analysis of platinum, a peak intensity ratio expressed by Aₘₐₓ/Aₐᵥₑ of 1.13 or more, where Aₘₐₓ denotes a maximum value of a white line within an energy range of 13,270 eV to 13,290 eV, and Aₐᵥₑ denotes an average absorption in an energy range of 13,290 eV to 13,390 eV.

### Advantageous Effects of Invention

The present disclosure can provide glass that can maintain a significantly high transmittance even when the glass contains some platinum.

### BRIEF DESCRIPTION OF THE DRAWINGS

FIG. 1 is a schematic cross-sectional view of optical glass for describing warpage of optical glass;

FIG. 2 is a schematic illustration of an example of the flow of a method for manufacturing glass according to one embodiment of the present disclosure;

FIG. 3 is a graph illustrating results of XAFS analysis obtained for the glass in Example 1;

FIG. 4 is a graph illustrating results of XAFS analysis obtained for the glass in Example 2;

FIG. 5 is a graph illustrating results of XAFS analysis obtained for the glass of Example 11; and

FIG. 6 is a graph illustrating results of XAFS analysis obtained for glass in Example 12.

### MODES FOR CARRYING OUT THE INVENTION

An embodiment of the present disclosure is described below. In the present disclosure, a numerical value range expressed using “to” includes the upper limit value and the lower limit value.

Thus far, it has been reported that the transmittance of manufactured glass decreases in a case where platinum has been mixed into molten glass during the manufacturing of glass. It has also been thought that this is caused by the presence of platinum mixed in the glass as either or both of platinum dioxide and tetravalent platinum ions, which cause the glass to be colored.

In fact, PTL 1 proposes a method to increase the transmittance of glass by suppressing the mixing in of tetravalent platinum.

However, in the manufacturing process of glass, the inventors of the present application have realized that suppressing the amount of tetravalent platinum that gets mixed into the molten glass does not necessarily increase the transmittance of the glass, and contrary to this, have also realized that there are instances where the transmittance does not decrease much even in cases where the glass contains a relatively large content of tetravalent platinum.

The inventors of the present application have diligently studied the cause of this fact and came to the and surmise that the presence of bivalent platinum rather than tetravalent platinum may have a significant influence on the transmittance of glass. However, such an idea has yet to be proposed, and the validity of such as idea has not been investigated before now.

Therefore, the inventors of the present application have diligently conducted research and development to verify the validity of their hypothesis. In doing so the inventors of the present application gained an understanding that the transmittance of the glass can be significantly increased by suppressing the amount of bivalent platinum contained in the glass, and with this newfound understanding, the inventors of the present application achieved the present disclosure.

That is, in one embodiment of the present disclosure, provided is glass having a refractive index of 1.55 or more and having, in X-ray absorption fine structure (XAFS) analysis of platinum, a peak intensity ratio expressed by Aₘₐₓ/Aₐᵥₑ of 1.13 or more, where Aₘₐₓ denotes a maximum value of a white line within an energy range of 13,270 eV to 13,290 eV, and Aₐᵥₑ denotes an average absorption in an energy range of 13,290 eV to 13,390 eV.

In one embodiment of the present disclosure, high-transmittance glass having a refractive index of 1.55 or more is provided.

Here, the glass according to one embodiment of the present disclosure is characterized by a peak intensity ratio expressed by Aₘₐₓ/Aₐᵥₑ of 1.13 or more where Aₘₐₓ denotes a maximum value of a white line within an energy range of 13,270 eV to 13,290 eV, and Aₐᵥₑ denotes an average absorption in an energy range of 13,290 to 13,390 eV.

The white line refers to the sharp absorption peak observed at the rise of the core excitation spectra.

XAFS analysis of platinum often yields absorption peaks in the energy range of 13,270 eV to 13,290 eV. Information on the valence of platinum is obtained from this absorption peak intensity.

Therefore, the peak intensity ratio Aₘₐₓ/Aₐᵥₑ can be used as an indicator of the amount of tetravalent platinum relative to the total platinum contained in the glass. That is, the higher the peak intensity ratio Aₘₐₓ/Aₐᵥₑ, the higher the amount of tetravalent platinum relative to the bivalent in the glass.

In particular, this peak intensity ratio Aₘₐₓ/Aₐᵥₑ is 1.13 or more in the glass according to one embodiment of the present disclosure, and thus the amount of bivalent platinum can be regarded as significantly suppressed.

According to the above-described investigation performed by the inventors of the present disclosure, the bivalent platinum contained in the glass is considered to have an adverse effect on the transmittance of the glass. In this regard, in one embodiment of the present disclosure, the proportion of bivalent platinum contained in the glass is significantly reduced. Therefore, in one embodiment of the present disclosure, a decrease in the transmittance of the glass can be significantly suppressed even when various types of platinum are mixed into the glass during the manufacturing process.

With the above features and effects, one embodiment of the present disclosure can provide high refractive index glass with significantly high transmittance despite containing a reasonable amount of platinum.

(Glass According to One Embodiment of the Present Disclosure)

Glass according to one embodiment of the present disclosure is described in more detail below.

The glass according to one embodiment of the present disclosure is, for example, a composition of

(1) a La₂O₃—B₂O₃ type,
(2) an SiO₂ type,
(3) a P₂O₅ type, or
(4) a Bi₂O₃ type.

The types (1) to (4) are indicated for the sake of convenience, focusing on the components contained in glass, and the boundaries between each type are not necessarily clear. For example, the glass according to one embodiment of the present disclosure may contain all of La₂O₃, B₂O₃, and SiO₂, and in such a case the glass composition may be determined as belonging to either type (1) or (2).

That is, the La₂O₃—B₂O₃ type may contain any other component as long as the glass contains both La₂O₃ and B₂O₃. The same is true of other types.

The glass of each type is described in more detail below.

In the description of the composition, “%” and “ppm” mean “mass %” and “mass ppm”, respectively, unless stated otherwise.

(1) La₂O₃—B₂O₃ type

Examples of the La2O3-B2O3 type glass include, for example, a glass containing 5 to 70% of La₂O₃ and 1 to 50% of B₂O₃ when the total content of the base composition is taken as 100%.

By setting La₂O₃ to 5% or more, a high refractive index can be obtained and dispersion can be made small (Abbe number can be made large). The lower limit of La₂O₃ is preferably 10%, more preferably 15%, and even more preferably 20%. The lower limit of La₂O₃ is more preferably 25%, even more preferably 30%, even more preferably 35%, even more preferably 40%, even more preferably 45%, even more preferably 47%, even more preferably 49%, and yet even more preferably 50.2%.

Also, by setting the content of La₂O₃ to 70% or less, the decrease in the meltability of the glass can be suppressed and the devitrification resistance of the glass can be enhanced. The upper limit of content of La₂O₃ is preferably 65%, more preferably 60% and even more preferably 55%. The upper limit of content of La₂O₃ is more preferably 53%, more preferably 52%, more preferably 51%, and even more preferably 50%.

B₂O₃ is a glass-forming component, and the content of B₂O₃ is preferably 1 to 50% when the total content of the base composition is taken as 100%.

By setting B₂O₃ to 1% or more, the devitrification resistance of the glass can be enhanced and the dispersion of the glass can be reduced. The lower limit of the content of the B₂O₃ component is preferably 3%, more preferably 4%, and even more preferably 5%. The lower limit of the content of the B₂O₃ component is more preferably 6%, even more preferably 7%, even more preferably 8%, even more preferably 9.2%, even more preferably 9.8%, even more preferably 10.4%, even more preferably 11.0% and yet even more preferably 11.4%.

Also, by setting the content of B₂O₃ to 50% or less, it is easy to obtain a high refractive index and the deterioration of chemical durability is suppressed. The upper limit of B₂O₃ is preferably 40%, more preferably 30%, and even more preferably 20%. The upper limit of B₂O₃ is more preferably 16%, more preferably 13%, more preferably 12%, more preferably 11.8%, and even more preferably 11.7%.

SiO₂ is an optional component. The content of SiO₂ is preferably 0 to 30% when the total content of the base composition is taken as 100%. By including SiO₂, the mechanical strength, stability, and chemical durability of the glass can be enhanced. The content of SiO₂ is preferably 1% or more, more preferably 2% or more, and even more preferably 3% or more. The content of SiO₂ is even more preferably 4% or more, even more preferably 5% or more, and even more preferably 6% or more.

Also, by setting the content of SiO₂ to 30% or less, a component for obtaining a high refractive index can be contained. The content of SiO₂ is preferably 20% or less, more preferably 15% or less, and even more preferably 10% or less. The content of SiO₂ is more preferably 9% or less, more preferably 8% or less, and even more preferably 7% or less.

MgO is an optional component. The content of MgO is preferably 0 to 20% when the total content of the base composition is taken as 100%. By including MgO, the mechanical strength of the glass can be enhanced. The content of MgO is more preferably 1% or more, more preferably 3% or more, and even more preferably 5% or more. When the MgO content is 20% or less, the devitrification temperature is lowered and favorable manufacturing characteristics are obtained. The content of MgO is even more preferably 15% or less, even more preferably 10% or less, and even more preferably 5% or less.

CaO is an optional component. The CaO content is preferably 0 to 30% when the total content of the base composition is taken as 100%. The chemical durability of the glass can be enhanced by including the CaO component. The CaO content is more preferably 1% or more, even more preferably 3% or more, and even more preferably 5% or more. When the CaO content is 30% or less, the devitrification temperature is lowered and favorable manufacturing characteristics are obtained. The CaO content is more preferably 20% or less, even more preferably 15% or less, and even more preferably 10% or less.

SrO is an optional component. The content of SrO is preferably 0 to 30% when the total content of the base composition is taken as 100%. The refractive index of the glass can be enhanced by including the SrO component. The content of SrO is more preferably 1% or more, even more preferably 3% or more, and even more preferably 5% or more. When the content of SrO is 30% or less, the devitrification temperature is lowered and favorable manufacturing characteristics are obtained. The content of SrO is more preferably 20% or less, even more preferably 15% or less, and even more preferably 10% or less.

BaO is an optional component. The content of BaO is preferably 0 to 40% when the total content of the base composition is taken as 100%. By including the BaO component, the refractive index of the glass can be enhanced. The content of BaO is more preferably 1% or more, even more preferably 3% or more, and even more preferably 5% or more. When the BaO content is 40% or less, the devitrification temperature is lowered and favorable manufacturing characteristics are obtained. The content of BaO is more preferably 30% or less, more preferably 20% or less, and even more preferably 15% or less.

ZnO is an optional component. The content of ZnO is preferably 0 to 30% when the total content of the base composition is taken as 100%. The refractive index of the glass can be enhanced by including the ZnO component. When the content of ZnO is 30% or less, the devitrification temperature is lowered and favorable manufacturing characteristics are obtained. The content of ZnO is more preferably 10% or less, even more preferably 2% or less, even more preferably 1% or less, and even more preferably 0.1% or less.

Li₂O is an optional component. The content of Li₂O is preferably 0 to 15% when the total content of the base composition is taken as 100%. The strength (Kc) and crack resistance (CIL) can be enhanced by including Li₂O. The content of Li₂O is more preferably 0.5% or more, even more preferably 1% or more, and even more preferably 3% or more. Also, when the content of Li₂O is 15% or less, the devitrification temperature is lowered and favorable manufacturing characteristics are obtained. The content of Li₂O is preferably 10% or less, more preferably 7% or less, and even more preferably 5% or less.

Na₂O is an optional component. The content of Na₂O is preferably 0 to 20% when the total content of the base composition is taken as 100%. A Na₂O content of 20% or less provides good crack resistance. The content of Na₂O is more preferably 15% or less, even more preferably 10% or less, and even more preferably 7% or less. In a case where the optical glass of this embodiment contains Na₂O, the devitrification temperature is lowered and favorable manufacturing characteristics are obtained. Also, the content of Na₂O is more preferably 0.5% or more, even more preferably 1% or more, and even more preferably 2% or more.

K₂O is an optional component. The content of K₂O is preferably 0 to 20% when the total content of the base composition is taken as 100%. A K₂O content of 20% or less provides good crack resistance. The content of K₂O is more preferably 15% or less, even more preferably 10% or less, and even more preferably 7% or less.

In a case where the glass contains K₂O, the devitrification temperature is lowered and favorable manufacturing properties are obtained. The content of K₂O is more preferably 0.5% or more, even more preferably 1% or more, and even more preferably 2% or more.

Cs₂O is an optional component. The content of Cs₂O is preferably 0 to 20% when the total content of the base composition is taken as 100%. When the content of Cs₂O is more than 0%, the devitrification temperature is lowered and favorable manufacturing characteristics are obtained. In a case where the optical glass of this embodiment contains Cs₂O, the content is more preferably 0.5% or more, even more preferably 1% or more, and even more preferably 2% or more. Also, a content of Cs₂O of 20% or less provides good crack resistance. The content of Cs₂O is more preferably 15% or less, even more preferably 10% or less, and even more preferably 7% or less.

Al₂O₃ is an optional component. The content of Al₂O₃ is preferably 0 to 55% or less when the total content of the base composition is taken as 100%. By including Al₂O₃, the strength of the glass and the stability of the glass can be enhanced. The content of Al₂O₃ is more preferably 1% or more, even more preferably 3% or more, and even more preferably 5% or more.

In addition, when the content of Al₂O₃ is 55% or less, the devitrification temperature is lowered and favorable manufacturing characteristics are obtained. The content of Al₂O₃ is more preferably 15% or less, even more preferably 10% or less, and even more preferably 8% or less.

TiO₂ is an optional component. The content of TiO₂ is preferably 0 to 55% when the total content of the base composition is taken as 100%. By including TiO₂, the refractive index of the glass and stability of the glass are enhanced. The content of TiO₂ is more preferably 1% or more, even more preferably 5% or more, and even more preferably 10% or more. The content of TiO₂ is even more preferably 11% or more and even more preferably 12% or more.

Also, when the content of TiO₂ is 55% or less, the devitrification temperature is lowered and the coloration of the glass can be suppressed. The content of TiO₂ is more preferably 35% or less, even more preferably 25% or less, and even more preferably 15% or less. The content of TiO₂ is even more preferably 14% or less and even more preferably 13% or less.

ZrO₂ is an optional component. The content of ZrO₂ is preferably 0 to 55% when the total content of the base composition is taken as 100%. By including ZrO₂, the refractive index of the glass is increased and the chemical durability of the glass can be enhanced. The content of ZrO₂ is more preferably 1% or more, even more preferably 2% or more, and even more preferably 3% or more.

Also, when the content of ZrO₂ is 55% or less, the devitrification temperature is lowered and favorable manufacturing characteristics are obtained. The content of ZrO₂ is more preferably 30% or less, even more preferably 20% or less, and even more preferably 10% or less.

WO₃ is an optional component. The content of WO₃ is preferably 0 to 10% when the total content of the base composition is taken as 100%. By including WO₃, the refractive index of the glass can be enhanced. The content of WO₃ is more preferably 0.1% or more, even more preferably 0.2% or more, and even more preferably 0.3% or more.

In addition, when the content of WO₃ is 10% or less, the devitrification temperature is lowered and coloration of the glass can be suppressed. The content of WO₃ is more preferably 1% or less, even more preferably 0.8% or less, and even more preferably 0.5% or less.

Bi₂O₃ is an optional component. The content of Bi₂O₃ is preferably 0 to 55% when the total content of the base composition is taken as 100%. With the inclusion of Bi₂O₃ in the glass, the refractive index of the glass can be enhanced. The content of Bi₂O₃ is more preferably 1% or more, even more preferably 5% or more, and even more preferably 10% or more.

Also, when the content of Bi₂O₃ is 55% or less, the devitrification temperature is lowered and coloration of the glass can be suppressed. The content of Bi₂O₃ is more preferably 35% or less, even more preferably 25% or less, and even more preferably 15% or less.

TeO₂ is an optional component. The content of TeO₂ is preferably 0 to 30% when the total content of the base composition is taken as 100%. By including TeO₂, the refractive index of the glass can be enhanced. The content of TeO₂ is more preferably 1% or more, even more preferably 5% or more, and even more preferably 10% or more.

Also, when the content of TeO₂ is 55% or less, the devitrification temperature can be lowered and the cost of raw materials can be reduced. The content of TeO₂ is more preferably 25% or less, even more preferably 20% or less, and even more preferably 15% or less.

Ta₂O₅ is an optional component. The content of Ta₂O₅ is preferably 0 to 30% when the total content of the base composition is taken as 100%. By including Ta₂O₅, the refractive index of the glass can be enhanced. The content of Ta₂O₅ is more preferably 1% or more, even more preferably 5% or more, and even more preferably 10% or more.

Also, when the content of Ta₂O₅ is 30% or less, the devitrification temperature can be lowered and the cost of raw materials can be reduced. The content of Ta₂O₅ is more preferably 25% or less, even more preferably 20% or less, and even more preferably 15% or less.

Nb₂O₅ is an optional component. The content of Nb₂O₅ is preferably 0 to 50% when the total content of the base composition is taken as 100%. By including Nb₂O₅, the refractive index of the glass can be enhanced. The content of Nb₂O₅ is more preferably 1% or more, even more preferably 2% or more, and even more preferably 3% or more. The content of Nb₂O₅ is even more preferably 4% or more, even more preferably 5% or more, and even more preferably 6% or more.

Also, when the content of Nb₂O₅ is 50% or less, the devitrification temperature can be lowered and the cost of raw materials can be reduced. The content of Nb₂O₅ is more preferably 25% or less, even more preferably 10% or less, and even more preferably 8% or less. The content of Nb₂O₅ is even more preferably 7.5%.

Y₂O₃ is an optional component. The content of Y₂O₃ is preferably 0 to 50% when the total content of the base composition is taken as 100%. By including Y₂O₃, the refractive index of the glass can be enhanced. The content of Y₂O₃ is more preferably 1% or more, even more preferably 2% or more, and even more preferably 3% or more. The content of Y₂O₃ is even more preferably 4% or more.

Also, when the content of Y₂O₃ is 50% or less, the devitrification temperature can be lowered and the cost of raw materials can be reduced. The content of Y₂O₃ is more preferably 25% or less, even more preferably 10% or less, and even more preferably 8% or less. The content of Y₂O₃ is even more preferably 7% or less.

Gd₂O₃ is an optional component. The content of Gd₂O₃ is preferably 0 to 50% when the total content of the base composition is taken as 100%. By including Gd₂O₃, the refractive index of the glass can be enhanced.

Also, when the content of Gd₂O₃ is 50% or less, the devitrification temperature can be lowered and the cost of raw materials can be reduced. The content of Gd₂O₃ is more preferably 25% or less, even more preferably 10% or less, and even more preferably 8% or less. The content of Gd₂O₃ is even more preferably 7% or less.

### (2) SiO₂ Type

Examples of SiO₂ type glass include, for example, glass containing 10 to 70% of SiO₂ and 1% or more of at least one selected from the group consisting of Nb₂O₅, Ta₂O₅, Li₂O, SrO, BaO, TiO₂, ZrO₂, WO₃, Bi₂O₃, TeO₂, and Ln₂O₃(Ln is at least one selected from the group consisting of Y, La, Gd, Yb, and Lu.) as a high refractive index component.

SiO₂ is a glass-forming component. The content of SiO₂ is 10 to 70% when the total content of the base composition is taken as 100%. In a case where the SiO₂ content is 10% or more, and the temperature T₂ at which the viscosity of the glass satisfies log rl=2 is in the preferred range, high strength and high crack resistance can be imparted to the glass, and the stability and chemical durability of the glass can be enhanced. The content of SiO₂ is preferably 15% or more, more preferably 20% or more, and even more preferably 25% or more. Also, when the content of SiO₂ is 70% or less, a component for obtaining a high refractive index can be contained. The content of SiO₂ is preferably 60% or less, even more preferably 50% or less, and even more preferably 40% or less.

Nb₂O₅ is an optional component. By setting the content of Nb₂O₅ to be 5% or more when the total content of the base composition is taken as 100%, the refractive index of the glass is enhanced and the Abbe number (ν_{d}) can be made small. The content of Nb₂O₅ is more preferably 15% or more, even more preferably 25% or more, and even more preferably 30% or more.

Also, when the content of Nb₂O₅ is 70% or less, the devitrification temperature can be lowered and the cost of raw materials can be reduced. The content of Nb₂O₅ is more preferably 65% or less, even more preferably 60% or less, and even more preferably 55% or less.

Ta₂O₅ is an optional component. The content of Ta₂O₅ is 0 to 30% when the total content of the base composition is taken as 100%. The refractive index can be enhanced by setting the content of Ta₂O₅ to 1% or more. The content of Ta₂O₅ is even more preferably 5% or more and even more preferably 10% or more.

Also, when the content of Ta₂O₅ is 30% or less, the devitrification temperature can be lowered and the cost of raw materials can be reduced. The content of Ta₂O₅ is more preferably 25% or less, even more preferably 20% or less, and even more preferably 15% or less.

Li₂O is an optional component. The content of Li₂O is preferably 0 to 15% when the total content of the base composition is taken as 100%. By including Li₂O, the strength (Kc) and crack resistance (CIL) can be enhanced. The content of Li₂O is even more preferably 0.5% or more, even more preferably 1% or more, and even more preferably 3% or more. Also, when the content of Li₂O is 15% or less, the devitrification temperature is lowered and favorable manufacturing characteristics are obtained. The content of Li₂O is preferably 10% or less, more preferably 7% or less, and even more preferably 5% or less.

SrO is an optional component. The content of SrO is preferably 0 to 30% when the total content of the base composition is taken as 100%. By including the SrO component the refractive index of the glass can be enhanced. The content of SrO is more preferably 1% or more, even more preferably 3% or more, and even more preferably 5% or more. When the content is 30% or less, the devitrification temperature is lowered and favorable manufacturing characteristics are obtained. The content of SrO is more preferably 20% or less, even more preferably 15% or less, and even more preferably 10% or less.

BaO is an optional component. The content of BaO is preferably 0 to 40% when the total content of the base composition is taken as 100%. By including the BaO component, the refractive index of glass can be enhanced. The BaO content is more preferably 1% or more, even more preferably 3% or more, and even more preferably 5% or more. When the content is 40% or less, the devitrification temperature is lowered and favorable manufacturing characteristics are obtained. The content of BaO is more preferably 30% or less, even more preferably 20% or less, and even more preferably 15% or less.

TiO₂ is an optional component. The content of TiO₂ is 0 to 55% when the total content of the base composition is taken as 100%. By including TiO₂, the refractive index of the glass and the stability of the glass can be enhanced. The content of TiO₂ is more preferably 1% or more, even more preferably 5% or more, and even more preferably 10% or more.

Also, when the content of TiO₂ is 55% or less, the devitrification temperature is lowered and the coloration of the glass can be suppressed. The content of TiO₂ is more preferably 35% or less, even more preferably 25% or less, and even more preferably 15% or less.

ZrO₂ is an optional component. The content of ZrO₂ is 0 to 55% when the total content of the base composition is taken as 100%. By including ZrO₂, the refractive index of the glass and the chemical durability of the glass can be enhanced. The content of ZrO₂ is more preferably 1% or more, even more preferably 2% or more, and even more preferably 3% or more.

Also, when the content of ZrO₂ is 55% or less, the devitrification temperature is lowered and favorable manufacturing characteristics are obtained. The content of ZrO₂ is more preferably 30% or less, even more preferably 20% or less, and even more preferably 10% or less.

WO₃ is an optional component. The content of WO₃ is 0 to 10% when the total content of the base composition is taken as 100%. By including WO₃, the refractive index of the glass can be enhanced. The content of WO₃ is more preferably 1% or more, even more preferably 2% or more, and even more preferably 3% or more.

In addition, when the content of WO₃ is 10% or less, the devitrification temperature is lowered and coloration of the glass can be suppressed. The content of WO₃ is more preferably 9% or less, more preferably 8% or less, and even more preferably 7% or less.

Bi₂O₃ is an optional component. The content of Bi₂O₃ is 0 to 55% when the total content of the base composition is taken as 100%. By including Bi₂O₃, the refractive index of the glass can be enhanced. The content of Bi₂O₃ is preferably 1% or less, more preferably 5% or more, and especially preferably 10% or more.

Also, when the content of Bi₂O₃ is 55% or less, the devitrification temperature is lowered and coloration of the glass can be suppressed. The content of Bi₂O₃ is more preferably 35% or less, even more preferably 25% or less, and even more preferably 15% or less.

TeO₂ is an optional component. The content of TeO₂ is 0 to 30% when the total content of the base composition is taken as 100%. By including TeO₂, the refractive index of the glass can be enhanced. The content of TeO₂ is more preferably 1% or more, even more preferably 5% or more, and even more preferably 10% or more.

Also, when the content of TeO₂ is 30% or less, the devitrification temperature can be lowered and the cost of raw materials can be reduced. The content of TeO₂ is more preferably 25% or less, even more preferably 20% or less, and even more preferably 15% or less.

3) P₂O₅ Type

An example of a P₂O₅ type glass is a glass containing, for example, 10 to 70 mass % of P₂O₅ and 1% or more of at least one selected from the group consisting of Nb₂O₅, Ta₂O₅, Li₂O, SrO, BaO, TiO₂, ZrO₂, WO₃, Bi₂O₃, TeO₂, and Ln₂O₃(Ln is at least one selected from the group consisting of Y, La, Gd, Yb, and Lu.) as a high refractive index component.

P₂O₅ is a glass-forming component included in the glass, and gives the glass manufacturable stability and reduces the glass transition temperature and the liquid phase temperature to great effect. However, when the content of P₂O₅ is less than 10% when the total content of the base composition is taken as 100%, the effect is insufficient. The content of P₂O₅ is preferably 15% or more, more preferably 20% or more, even more preferably 30% or more, and especially preferably 40% or more. Also, when the content of P₂O₅ is 70% or less, good chemical durability is obtained. The content of P₂O₅ is preferably 65% or less, more preferably 60% or less, even more preferably 55% or less, especially preferably 50% or less.

The high refractive index component is the same as in the case of the SiO₂ type glass in (2) described above, so further description is omitted.

(4) Bi₂O₃ Type

An example of Bi₂O₃ type glass is, when the total content of the base composition is taken as 100%, glass that contains to 95% of Bi₂O₃ and contains 1% or more of at least one selected from the group consisting of Nb₂O₅, Ta₂O₅, Li₂O, SrO, BaO, TiO₂, ZrO₂, WO₃, TeO₂, and Ln₂O₃(Ln is at least one selected from the group consisting of Y, La, Gd, Yb, and Lu.) as a high-refractive-index component.

The refractive index can be increased by including Bi₂O₃ at 5% or more. The lower limit of Bi₂O₃ is preferably 10%, more preferably 15%, and even more preferably 20%. The lower limit of Bi₂O₃ is even more preferably 25%, even more preferably 30%, and even more preferably 35%.

Also, by setting the content of Bi₂O₃ to 95% or less, a decrease in the meltability of the glass is suppressed and the devitrification resistance of the glass is enhanced. The upper limit of Bi₂O₃ is preferably 90%, more preferably 85% and even more preferably 80%. The upper limit of Bi₂O₃ is even more preferably 75%, even more preferably 70%, and even more preferably 65%.

P₂O₅ is an optional component. The content of P₂O₅ is preferably 0 to 50% when the total content of the base composition is taken as 100%. The inclusion of P₂O₅ gives the glass manufacturable stability and reduces the glass transition temperature and the liquid phase temperature. The content of P₂O₅ is more preferably 1% or more, even more preferably 2% or more, and even more preferably 3% or more. The content of P₂O₅ is even more preferably 4% or more and even more preferably 5% or more.

Also, when the content of P₂O₅ is 50% or less, good chemical durability is obtained. The content of P₂O₅ is more preferably 25% or less, even more preferably 20% or less, and even more preferably 15% or less. The content of P₂O₅ is even more preferably 10% or less.

TeO₂ is an optional component. The content of TeO₂ is 0 to 50% when the total content of the base composition is taken as 100%. By including TeO₂, the refractive index of the glass can be enhanced. The content of TeO₂ is more preferably 1% or more, even more preferably 2% or more, and even more preferably 5% or more.

Also, when the content of TeO₂ is 50% or less, the devitrification temperature can be lowered and the cost of raw materials can be reduced. The content of TeO₂ is more preferably 25% or less, even more preferably 20% or less, and even more preferably 15% or less.

Nb₂O₅ is an optional component. The content of Nb₂O₅ is preferably 0 to 50% when the total content of the base composition is taken as 100%. By including Nb₂O₅, the refractive index of the glass can be increased and the Abbe number (ν_{d}) can be made small. The content of Nb₂O₅ is more preferably 1% or more, even more preferably 2% or more, even more preferably 3% or more, even more preferably 4% or more, and even more preferably 5% or more.

Also, when the content of Nb₂O₅ is 50% or less, the devitrification temperature can be lowered and the cost of raw materials can be reduced. The content of Nb₂O₅ is more preferably 25% or less, even more preferably 20% or less, even more preferably 15% or less, and even more preferably 10% or less.

Other high-refractive-index components are the same as in the case of SiO₂ type glass in (2) described above, so further description is omitted.

Here, as described above, in one embodiment of the present disclosure, the transmittance can be significantly increased even in a case where the glass contains a reasonable amount of platinum component.

Therefore, in one embodiment of the present disclosure, unlike in the past, it is not necessary to strictly manage or control the mixing in of platinum in the glass manufacturing process. For example, platinum may be present in the glass at 3 mass ppm or more, 3.8 mass ppm or more, 4 mass ppm or more, 5 mass ppm or more, 6 mass ppm or more, 7 mass ppm or more, 8 mass ppm or more, 9 mass ppm or more, or mass ppm or more.

However, when the content of platinum in the glass becomes exceedingly high, it is difficult to sufficiently suppress the total amount of bivalent platinum ions, and consequently, the transmittance might decrease. For this reason, the content of platinum in the glass is preferably, for example, 30 mass ppm or less, and particularly preferably especially 20 mass ppm or less.

### (Other Characteristics)

### (Refractive Index)

The glass according to one embodiment of the present disclosure has a refractive index of 1.55 or more. The refractive index is preferably 1.65 or more. The refractive index is more preferably 1.71 or more, even more preferably 1.73 or more, even more preferably 1.75 or more, even more preferably 1.77 or more, even more preferably 1.79 or more, even more preferably 1.81 or more, even more preferably 1.83 or more, even more preferably 1.85 or more, even more preferably 1.87 or more, even more preferably 1.89 or more, even more preferably 1.91 or more, even more preferably 1.93 or more, even more preferably 1.95 or more, even more preferably 1.955 or more, and even more preferably 1.959.

In this application, the refractive index is the refractive index of the d-line and is usually expressed by n_{d}.

(Peak Intensity Ratio Aₘₐₓ/Aₐᵥₑ)

As described above, the glass according to one embodiment of the present disclosure is characterized by a peak intensity ratio Aₘₐₓ/Aₐᵥₑ of 1.13 or more in XAFS analysis of platinum. The peak intensity ratio Aₘₐₓ/Aₐᵥₑ is preferably 1.16 or more, and more preferably 1.20 or more.

By setting the peak intensity ratio Aₘₐₓ/Aₐᵥₑ to 1.13 or more, the proportion of the bivalent platinum can be significantly suppressed and the decrease in the glass transmittance can be suppressed, even when the glass contains platinum.

### (Internal Transmittance)

The glass according to one embodiment of the present disclosure has an internal transmittance of 90% or more with respect to light with a wavelength of 450 nm for a thickness of 10 mm. The internal transmittance is preferably 92% or more and more preferably 95% or more.

In the present application, the internal transmittance of a glass with a thickness of 10 mm with respect to light with a wavelength of 450 nm can be determined from measurements of two types of external transmittance with different plate thicknesses and the following Formula (1). The external transmittance refers to the transmittance including the surface reflection loss.

$$log X = - \frac{log T 1 - log T 2}{Δ d} \times 10 \qquad Formula ( 1 )$$

Where X is the internal transmittance of the glass with a thickness of 10 mm, T1 and T2 are both external transmittances, and Δd is the difference between the thicknesses of the samples.

### (Form of the Glass According to One Embodiment of the Present Disclosure)

### (Shape)

The optical glass of the present disclosure is preferably a glass plate with a thickness of 0.01 to 2.0 mm. If the thickness is 0.01 mm or more, breakage during handling and processing of optical glass can be suppressed. In addition, deflection of the optical glass due to the own weight of the optical glass can be suppressed. This thickness is more preferably 0.1 mm or more, even more preferably 0.3 mm or more, and even more preferably 0.5 mm or more. Also, if the thickness is 2.0 mm or less, an optical element using optical glass can be made lightweight. This thickness is more preferably 1.5 mm or less, even more preferably 1.0 mm or less, and even more preferably 0.8 mm or less.

In a case where the optical glass of the present disclosure is a glass plate, the area of one main surface is preferably 8 cm² or more. If this area is 8 cm² or more, a large number of optical elements can be arranged and productivity can be enhanced. This area is more preferably 30 cm² or more, even more preferably 170 cm² or more, even more preferably 300 cm² or more, and especially preferably 1,000 cm² or more. Also, if the area is 6,500 cm² or less, the glass plate is easy to handle and breakage during handling and processing of the glass plate can be suppressed. This area is more preferably 4,500 cm² or less, even more preferably 4,000 cm² or less, even more preferably 3,000 cm² or less, and especially preferably 2,000 cm² or less.

### (LTV)

In the case where the optical glass of the present disclosure is a glass plate, the Local Thickness Variation (LTV) in 25 cm² on one main surface is preferably 2 μm or less. By having flatness in this range, a nanostructure with a desired shape can be formed on one main surface by using imprinting technology and the like, and also desired lightguide properties can be obtained. In particular, a ghost phenomenon and distortion due to the difference in optical path lengths can be prevented in the lightguide. The LTV is more preferably 1.8 μm or less, even more preferably 1.6 μm or less, even more preferably 1.4 μm or less, and especially preferably 1.2 μm or less.

### (Warpage)

When the optical glass of the present disclosure is made into a circular glass plate 8 inches in diameter, the warpage is preferably 50 μm or less. If the warpage of the glass plate is 50 μm or less, a nanostructure of the desired shape can be formed on one main surface by imprinting technology or the like, and the desired lightguide properties can be obtained. When two or more lightguides are to be obtained, lightguides of satisfactory quality are stably obtained. The warpage of this glass plate is more preferably 40 μm or less, even more preferably 30 μm or less, and particularly preferably 20 μm or less.

When the optical glass of the present disclosure is made into a circular glass plate 6 inches in diameter, the warpage is preferably 30 μm or less. If the warpage of this glass plate is 30 μm or less, a nanostructure of the desired shape can be formed on one main surface by imprinting technology or the like, and the desired lightguide properties can be obtained. When two or more lightguides are to be obtained, lightguides of satisfactory quality are stably obtained. The warpage of this glass plate is more preferably 20 μm or less, even more preferably 15 μm or less, and especially preferably 10 μm or less.

In addition, when a square glass plate with 6 inches on each side is used, the warpage is preferably 100 μm or less. If the warpage of this glass plate is 100 μm or less, a nanostructure of the desired shape can be formed on one main surface by imprinting technology or the like, and the desired lightguide properties can be obtained. When two or more lightguides are to be obtained, lightguides of satisfactory quality are stably obtained. The warpage of this glass plate is more preferably 70 μm or less, even more preferably 50 μm or less, even more preferably 35 μm or less, and especially preferably 20 μm or less.

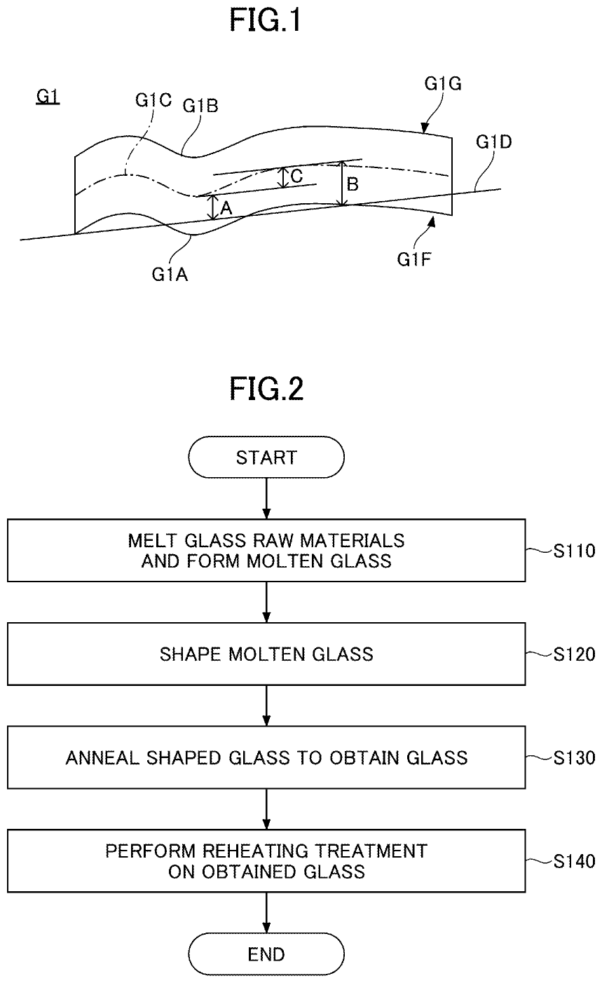

FIG. 1 is a cross-sectional view of the optical glass of the present disclosure and is denoted as a glass plate G1. “Warpage” is defined as follows. In any cross-section passing through the center of one main surface G1F of the glass plate G1 and perpendicular to the main surface G1F of the glass plate G1, a base line G1D of the glass plate and a center line G1C for the glass plate G1 are determined and the difference C between a maximum value B and a minimum value A of the vertical-direction distance between the base line G1D and the center line G1C is taken as the warpage.

The intersection line where the perpendicular cross-section meets the one main surface G1F of the glass plate G1 is referred to as bottom line GlA. The intersection line where the perpendicular cross-section meets the other main surface G1G of the glass plate G1 is referred to as top line G1B. The center line 1C is a line that connects thickness-direction center points of the glass plate G1. The center line G1C is calculated by determining midpoints, along the direction of laser irradiation which is described further below, between the bottom line G1A and the top line G1B.

A base line G1D is determined in the following manner. First, a bottom line G1A is calculated by a measuring method in which any influence of the weight of the glass plate G1 itself is eliminated. From the bottom line GlA, a straight line is determined by the least squares method. The determined straight line is the base line G1D. As the method in which any influence of the weight of the glass plate G1 itself is eliminated, a common method is used.

For example, one main surface G1F of the glass plate G1 is supported at three points. The glass plate G1 is irradiated with laser light using a laser displacement meter to measure the heights of the one main surface G1F and the other main surface G1G of the glass plate G1 from any base plane.

Next, the glass plate G1 is reversed and supported at three points located on the other main surface G1G which face the three points at which said one main surface G1F was supported, and the heights of said one main surface G1F and the other main surface G1G of the glass plate G1 from a base plane are measured.

The respective heights of each measurement point measured before and after the reversal are averaged, thereby eliminating the influence of the weight of the glass plate G1 itself. For example, heights of the one main surface G1F are measured before reversal in the manner shown above. The glass plate G1 is reversed, and heights of the other main surface G1G are then measured in positions corresponding to the measurement points on said one main surface G1F. Likewise, heights of the other main surface G1G are measured before reversal. After the glass plate G1 is reversed, heights of said one main surface G1F are measured in positions corresponding to the measurement points on the other main surface G1G.

The warpage is measured, for example, with a laser displacement meter.

### (Surface Roughness)

In the optical glass of this embodiment, surface roughness Ra of one main surface is preferably 2 nm or less. By having an Ra in this range, a nanostructure can be formed with a desired shape on one main surface by using the imprinting technology or the like, and also desired lightguide properties can be obtained. In particular, irregular reflection at an interface is suppressed in the lightguide, and a ghost phenomenon and distortion can be suppressed. The Ra is more preferably 1.7 nm or less, even more preferably 1.4 nm or less, yet even more preferably 1.2 nm or less, and particularly preferably 1 nm or less. The surface roughness Ra is an arithmetic mean roughness defined in Japanese Industrial Standards (JIS) B0601 (2001). In this specification, it is a value obtained by measuring an area of 10 μm×10 μm by using an atomic force microscope (AFM).

### (Manufacturing Method of Glass According to the First Embodiment of the Present Disclosure)

Next, an example of a method for manufacturing glass according to an embodiment of the present disclosure having the aforementioned characteristics is described. However, it will be apparent to those skilled in the art that the following method of manufacturing glass is merely an example and that the glass according to one embodiment of the present disclosure may be manufactured by another method.

FIG. 2 illustrates the flow of a method for manufacturing glass (hereinafter, referred to as the “first manufacturing method”) according to one embodiment of the present disclosure.

As illustrated in FIG. 2, the first manufacturing method includes a step of melting raw materials to form molten glass (S110), a step of shaping molten glass (S120), a step of annealing the shaped glass to obtain the glass (S130), and a step of performing reheating treatment on the obtained glass (S140).

Each step is described below.

### (Step S110)

First, the glass raw materials are prepared and then the glass raw materials are melted.

The glass raw materials are prepared based on the glass that is ultimately obtained.

Normally, the melting of glass raw materials is carried out in a melting furnace. In the first manufacturing method, some platinum may be mixed in the molten glass. Therefore, in the first manufacturing method, a melting furnace containing platinum members can be used.

### (Step S120)

Next, the molten glass is shaped.

The molten glass shaping method is not particularly limited and conventional methods may be used. For example, in a case where the float process is used, the shaped glass, that is, glass ribbons, can be formed by feeding molten glass to a bath containing molten metal and having the molten glass conveyed on the molten metal.

### (Step S130)

The shaped glass is then annealed to room temperature. The method of annealing is not particularly limited and conventional methods may be used.

By doing so, a first glass is obtained.

### (Process S140)

The steps from step S110 to step S130 yield the first glass. However, it is likely that the first glass contains each valence of platinum in an uncontrolled state. In particular, when the proportion of bivalent platinum is high, the desired transmittance may be unobtainable.

Therefore, next, reheating treatment is performed. By performing reheating treatment on the first glass, the proportion of tetravalent platinum contained in the first glass can be increased and the proportion of bivalent platinum can be decreased.

The reheating treatment conditions are not particularly limited as long as the peak intensity ratio Aₘₐₓ/Aₐᵥₑ is 1.13 or more for the glass obtained after the treatment.

For example, the reheating treatment may be performed at a temperature of less than or equal to the glass transition temperature (Tg)+40 degrees Celsius.

The reheating treatment time varies with the treatment temperature, but ranges from, for example, 0.5 hours to 100 hours.

The reheating treatment is performed in an oxidizing atmosphere, for example, an atmospheric atmosphere. Oxygen concentration is preferably in the range of 15% to 30%.

After the above reheating treatment, the glass according to one embodiment of the present disclosure can be manufactured.

Furthermore, in the optical glass of this embodiment, it is preferable to perform an operation to increase the amount of moisture in the molten glass in the melting step to obtain the molten glass by heating and melting the glass raw material in a melting vessel. Operations to increase the amount of water in the glass are not limited, and may include adding water vapor to the atmosphere for melting or bubbling the vapor-containing gas into the melt. Although the operation to increase the moisture content is not essential, this operation can be performed for the purposes of enhancing the transmittance and enhancing clarity.

In addition, the optical glass of this embodiment containing an alkali metal oxide of Li₂O or Na₂O can be chemically strengthened by replacing Li ions with Na ions or K ions or replacing Na ions with K ions. In other words, the strength of optical glass can be enhanced by performing chemical strengthening.

Optical members such as the glass plates and shaped glass manufactured in this way are useful in a variety of optical elements, especially (1) wearable devices, such as glasses equipped with a projector; glasses-type and goggle-type displays; virtual-reality or augmented-reality display devices; lightguides, filters and lenses that are used for virtual image displace devices; and the like, and (2) lenses and cover glass used for in-vehicle cameras and robotic visual sensors. It is also suitably used for applications exposed to harsh environments, such as in-vehicle cameras. It is also suitable for applications such as glass plates for organic EL, wafer-level lens array substrates, lens unit substrates, lens-forming substrates by an etching method, and optical waveguides.

The optical glass of this embodiment described above has a high refractive index and low density, as well as good manufacturing characteristics, and is suitable as optical glass for wearable devices, for mounting on vehicles, and for mounting on robots. Moreover, an optical component obtained by coating a main surface of this optical glass with an antireflection film constituted of a multilayered dielectric film including 4 to 10 layers formed by alternately depositing a low-refractive index film of, for example, SiO₂, and a high-refractive index film of, for example, TiO₂ is also suitable for use in wearable devices, for mounting on vehicles, and for mounting on robots.

Next, the Examples of the present disclosure are described.

Glass samples were manufactured and the characteristics were evaluated by the methods described below. In the following descriptions, Example 1 and Example 2 are Examples whereas Examples 11 and 12 are comparative examples. In each case, the glass composition was the La₂O₃—B₂O₃ type described above.

### Example 1

A pre-determined amount of raw powder was uniformly mixed together to obtain a mixed powder. The composition of the mixed powder is expressed in terms of oxide is:

La₂O₃: 50.5 mass %,
B₂O₃: 11.6 mass %,
SiO₂: 6.0 mass %,
TiO₂: 13.1 mass %,
ZrO₂: 5.0 mass %,
WO₃: 0.3 mass %,
Nb₂O₃: 7.3 mass %, and
Y₂O₃: 6.2 mass %.

Next, the mixed powder was melted in a platinum crucible at 1250 degrees Celsius under atmosphere to obtain molten glass. The dew point of the atmosphere was 80 degrees Celsius, and the retention time at 1250 degrees Celsius was 100 minutes.

Next, a metal mold having a length×width×height=60 mm×width 50 mm×height 30 mm was prepared, and molten glass was injected into this mold. The mold was retained at 730 degrees C. for 1 hour and then annealed to room temperature at a cooling rate of approximately 1 degree C./min.

By doing so, glass block A was obtained.

Next, reheating treatment was performed on the glass block A. The temperature of the reheating treatment was set at 745 degrees C. (glass transition temperature Tg+40 degrees Celsius) and held at this temperature for 96 hours in atmosphere.

A glass sample (hereinafter, referred to as “Glass 1”) was manufactured by the above-described steps.

### Example 2

A pre-determined amount of raw powder was uniformly mixed together to obtain a mixed powder. The composition of the mixed powder is substantially the same as that in Example 1.

Next, the mixed powder was melted in a platinum crucible at 1350 degrees Celsius under atmosphere to obtain molten glass. The dew point of the atmosphere was 80 degrees Celsius, and the retention time at 1350 degrees Celsius was 180 minutes.

Next, the molten glass was injected into the previously-described mold. The mold was retained at 730 degrees C. for 1 hour and then annealed to room temperature at a cooling rate of approximately 1 degree C./min.

By doing so, glass block B was obtained.

Next, reheating treatment was performed on the glass block B. The temperature of the reheating treatment was set at 745 degrees C. (glass transition temperature Tg+40 degrees Celsius) and held at this temperature for 96 hours in air.

A glass sample (hereinafter, referred to as “Glass 2”) was manufactured by the above-described steps.

### Example 11

A glass sample was produced by using a method substantially the same as that of Example 1. However, in Example 11, reheating treatment was not performed.

The obtained glass sample is referred to as “Glass 11”.

### Example 12

A glass sample was produced by using a method substantially the same as that of Example 2. However, in Example 12, reheating treatment was not performed.

The obtained glass sample is referred to as “Glass 12”.

### (Evaluation)

### <Refractive Index>

The refractive index nd of each glass was measured by a V-block method using a Kalnew KPR-2000.

The V-block method is a method specified in JIS B 7071-2:2018.

### <Evaluation of Platinum Amount>

ICP mass spectrometry was used to determine the amount of platinum contained in each glass.

### <Evaluation of Peak Intensity Ratio of Platinum>

Using a small cutting machine (made by Maruto Instrument Co., Ltd.), each glass was cut to a dimension of approximately 10 mm×10 mm. Then, for the cut glass, a grinder (manufactured by Shuwa Industry Company Limited; SGM-6301) and a single-side grinder (manufactured by Engis Japan Corporation; EJ-380IN) were used for surface polishing to produce a sample (hereinafter, referred to as “Sample A”) 10 mm long×10 mm wide×5 mm thick.

Using the obtained sample A, XAFS analysis was performed to determine the peak intensity ratio of platinum, that is, Aₘₐₓ/Aₐᵥₑ.

XAFS analysis was performed at High Energy Accelerator Research Organization (BL 12 C). XAFS analysis was also performed in the energy range of 12,700 eV to 13,800 eV.

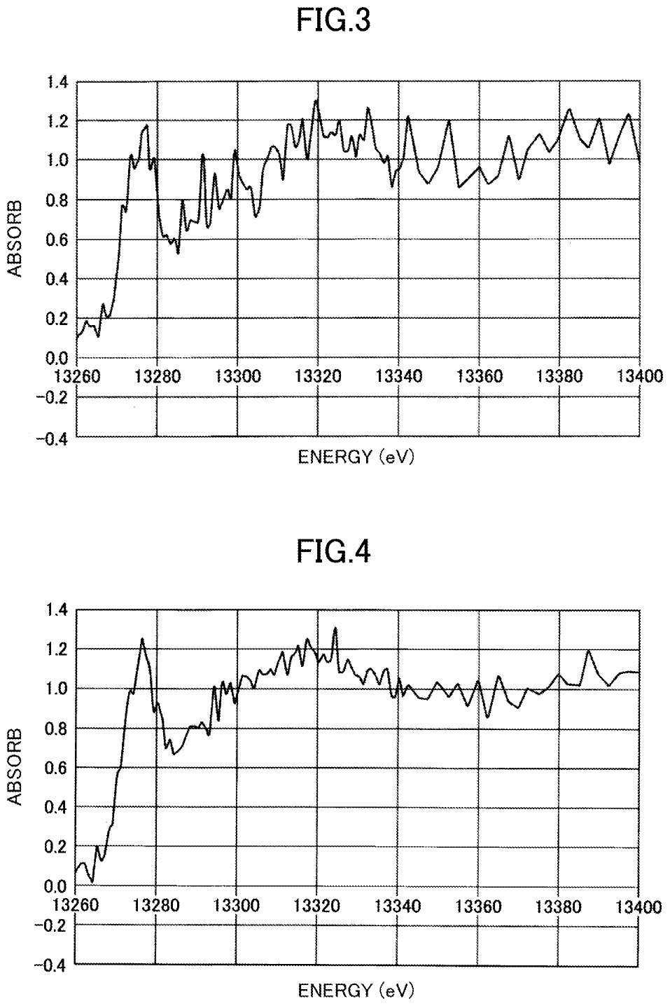

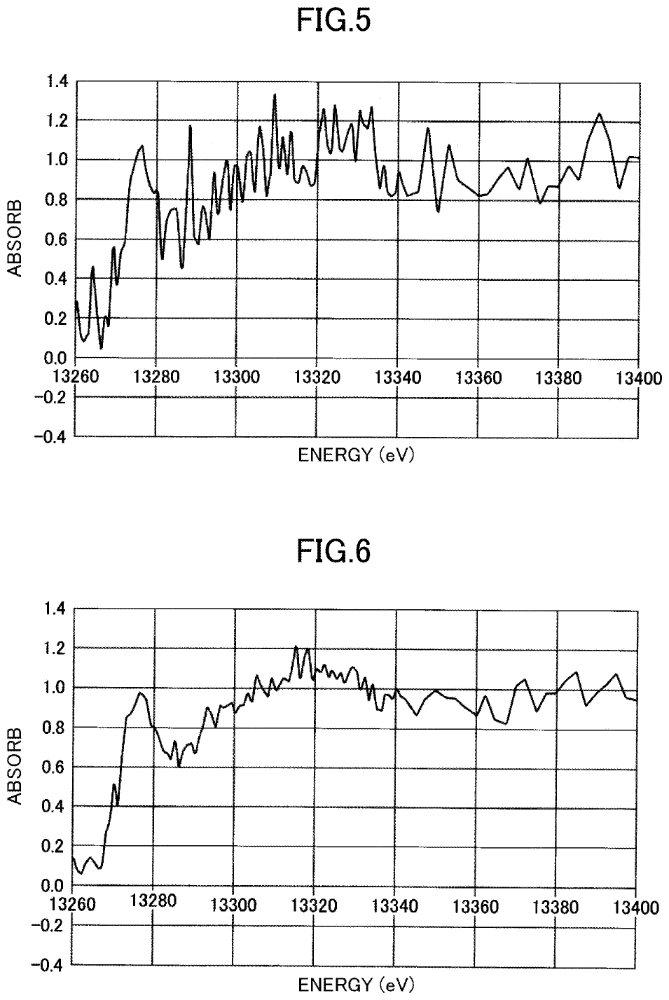

FIGS. 3 to 6 illustrate the XAFS analysis results individually obtained for glass 1, glass 2, glass 11, and glass 12.

### <Internal Transmittance>

Using a small cutting machine (made by Maruto Instrument Co., Ltd.), each glass was cut to a dimension of approximately 30 mm×30 mm. Then, for the cut glass, a grinder (manufactured by Shuwa Industry Company Limited; SGM-6301) and a single-side grinder (manufactured by Engis Japan Corporation; EJ-380IN) was used for surface polishing to produce a sample (hereinafter, referred to as “Sample B”) 30 mm long×30 mm wide×10 mm thick.

A spectrophotometer (manufactured by Hitachi High-Tech Corporation; U-4100) was used to measure the transmittance of each sample B and determine the internal transmittance with respect to light with a wavelength of 450 nm at a plate thickness of 10 mm.

The results of each evaluation are summarized in Table 1.

TABLE 1

| | | Platinum | Peak | |
|---|---|---|---|---|
| | | content | intensity | Internal |
| | Refractive | (mass | ratio | transmittance |
| Glass | index n_{d} | ppm) | Aₘₐₓ/Aₐᵥₑ | (%) |
| 1 | 1.96 | 3.8 | 1.16 | 95.5 |
| 2 | 1.96 | 14.0 | 1.21 | 90.0 |
| 11 | 1.96 | 3.8 | 1.12 | 92.0 |
| 12 | 1.96 | 14.0 | 1.00 | 80.2 |

### <Evaluation of LTV, Warpage, and Surface Roughness (Ra)>

Using a small cutting machine (made by Maruto Instrument Co., Ltd.), each glass was cut into a circular glass plate 6 inches in diameter. Then, for the cut glass, a grinder (manufactured by Shuwa Industry Company Limited; SGM-6301) and a single-side grinder (manufactured by Engis Japan Corporation; EJ-380IN) were used for surface polishing to produce a sample (hereinafter, referred to as “Sample C”) 6 inches in diameter and 1 mm thick. Since the glass 1 and 2 have good manufacturing characteristics, the size of residual bubbles is small and the number of residual bubbles is small, so that a glass plate free from defects such as bubbles, foreign matter, striae, and phase separation can be obtained. Therefore, an optical glass with an LTV value of 2 μm or less, a warpage value (a circular glass plate with a diameter of 6 inches) of 30 μm or less, and a Ra value of 2 nm or less when a sample of the size described above is formed can be obtained.

The thickness of the glass plate was measured by a non-contact laser displacement meter (Nanometro, Kuroda Precision Industries Ltd.) at 3 mm intervals, and LTV was calculated, resulting in LTV values of 1.1 μm and 1.0 μm.

The heights of the two main surfaces of the glass plate were measured by a non-contact laser displacement meter (Nanometro, Kuroda Precision Industries Ltd.) on a disk-shaped sample with a diameter of 6 inches×1 mm at 3 mm intervals, and warpage was calculated by the above described method, resulting in warpage values of 10 μm and 9 μm.

Surface roughness was measured using an atomic force microscope (AFM) (Oxford Instruments) in an area of 10 μm×10 μm for a plate-shaped sample measuring 20 mm×20 mm×1 mm, resulting in surface roughness (Ra) values of 0.60 nm and 0.55 nm.

Table 1 illustrates that each glass has a high refractive index. It was also found that platinum was contained in each glass.

In Table 1, the peak intensity ratios of platinum Aₘₐₓ/Aₐᵥₑ for glass 11 and glass 12 were both 1.12 or less. In contrast, the peak intensity ratios of platinum Aₘₐₓ/Aₐᵥₑ for glass 1 and glass 2 were both 1.16 or more. From this result, the proportion of bivalent platinum contained in the glass can be regarded as suppressed in glass 1 and glass 2.

In addition, glass 1 had an internal transmittance of 95.5%, which was higher than the internal transmittance of glass 11, even though the contained platinum content was equivalent to that of glass 11. Similarly, glass 2 had an internal transmittance of 90.0%, which was higher than that of glass 12, even though the contained platinum content was equivalent to that of glass 12.

Thus, it was confirmed that glass 1 and glass 2 with a platinum peak intensity ratio of Aₘₐₓ/Aₐᵥₑ of 1.13 or more had high transmittance even though platinum was contained in the glass. In particular, it was confirmed that high transmittance could be obtained in glass 2 despite the presence of 14 mass ppm platinum in the glass.

What is claimed is:

1. Glass that has a refractive index of 1.55 or more, and has, in an x-ray absorption fine structure (XAFS) analysis of platinum, a peak intensity ratio expressed by Aₘₐₓ/Aₐᵥₑ of 1.13 or more, where Aₘₐₓ denotes a maximum value of a white line within an energy range of 13,270 eV to 13,290 eV, and Aₐᵥₑ denotes an average absorption in an energy range of 13,290 eV to 13,390 eV.

2. The glass according to claim 1, wherein the glass has a composition of:
(1) a La₂O₃—B₂O₃ type,
(2) an SiO₂ type,
(3) a P₂O₅ type, or
(4) a Bi₂O₃ type.

3. The glass according to claim 1, wherein the glass has an internal transmittance of 90% or more with respect to light with a wavelength of 450 nm for a thickness of 10 mm.

4. The glass according to claim 1, wherein a platinum content of the glass is 10 mass ppm or more.
